(19) United States
(12) Patent Application Publication
(10) Pub. No.: US 2026/0139665 A1
(43) Pub. Date: May 21, 2026

(54) SUSPENSION ELEMENT FOR A PUMP ELEMENT IN A PUMP HOUSING, PUMP ARRANGEMENT, VEHICLE SEAT, AND MOTOR VEHICLE

(71) Applicant: Volkswagen Aktiengesellschaft, Wolfsburg (DE)

(72) Inventors: Martin KOSCHE, Gifhorn (DE); Johann GIGGEL, Gardelegen (DE); Ralph BOETTGER, Ebendorf (DE); Viktor PETKER, Wolfsburg (DE)

(73) Assignee: Volkswagen Aktiengesellschaft, Wolfsburg (DE)

(21) Appl. No.: 19/419,890

(22) Filed: Dec. 15, 2025

Related U.S. Application Data
(63) Continuation of application No. PCT/EP2024/065533, filed on Jun. 6, 2024.

(30) Foreign Application Priority Data
Jun. 15, 2023 (DE) 10 2023 205 617.8

(51) Int. Cl. F04B 53/00; B60N 2/66

(52) U.S. Cl. CPC F04B 53/003; B60N 2/665

(57) ABSTRACT

A suspension element for an pneumatic pump element in a pump housing, in particular of an adjustable lumbar support of a vehicle seat. The suspension element has a holding ring into which the pump element is insertable and at least two fastening elements which protrude radially from the holding ring, and which are uniformly distributed over the circumference of the holding ring, and which are designed in one piece with the holding ring and are elastically deformable, at least in areas, in order to support the pump element in the pump housing in a floating and vibration-damping manner.

This nonprovisional application is a continuation of International Application No. PCT/EP2024/065533, which was filed on Jun. 6, 2024, and which claims priority to German Patent Application No. 10 2023 205 617.8, which was filed in Germany on Jun. 15, 2023, and which are both herein incorporated by reference.

### BACKGROUND OF THE INVENTION

### Field of the Invention

The invention relates to a suspension element for a pneumatic pump element in a pump housing, in particular of an adjustable lumbar support of a vehicle seat. The invention further relates to a pump arrangement with such a suspension element, a vehicle seat with such a pump arrangement, and a motor vehicle with such a vehicle seat.

### Description of the Background Art

Suspensions, made up of multiple elements, for pump elements are known from the prior art. For example, a suspension having a ring element that is arranged around a pump motor and that has two radially opposite protrusions is known from German Unexamined Patent application DE 10 2019 109 928 A1, which corresponds to US 2020/0324672. The protrusions in each case are situated opposite from pocket-shaped fixing elements in a pump housing. Accommodated in each of the fixing elements is an end coil of a coil spring that surrounds one of the protrusions on the other side. The coil springs are used as support elements in order to support the pump motor in the pump housing in the radial direction. Further damping elements, in particular made of foam, for preventing a collision between the pump motor and the pump housing are situated on the inner side of the pump housing.

Also known are pneumatic lumbar shield arrangements, for example for vehicle seats of motor vehicles, which allow adjustment of the spinal column support (lordosis) for a user-specific natural contour of the spinal column in the lumbar region (S contour of the spinal column) via filling of air cushions or air pockets which in particular overlap in areas. Air is generally supplied by such a pump motor. Filling, venting, and maintenance of the air pressure are controlled via control devices and valve assemblies.

### SUMMARY OF THE INVENTION

It is therefore an object of the present invention to provide an improved suspension for a pump motor, in particular for use in a lumbar shield arrangement, which is less complex and has a smaller number of components.

According to an example of the invention, it is provided that the suspension element can have a holding ring into which the pump element is insertable and at least two fastening elements which protrude radially from the holding ring, and which in particular are uniformly distributed over the circumference of the holding ring, and which are designed in one piece with the holding ring and are elastically deformable, at least in areas, in order to support the pump element in the pump housing in a floating and vibration-damping manner. A suspension element having this type of design provides an advantageous one-piece solution for radial and axial support of the pump arrangement, compared to solutions known from the prior art, mentioned at the outset, which always have a multipart design. In addition, separate damping elements mentioned at the outset may be dispensed with. Alternatively, at least one damping element that is likewise designed in one piece with the holding ring is provided, so that in any case the one-piece design is always ensured. Furthermore, the one-piece design of the suspension element provides a particularly advantageous option for jointly manufacturing the holding ring and fastening elements, in which in particular no additional production step is needed for manufacturing the fastening elements. Overall, a solution is thus provided which ensures particularly easy installation. In particular, the pump element and the suspension element form a particularly advantageous pre-assembled unit. The pump element in particular includes a pump motor or is designed as a pump motor. The suspension element in particular includes an elastomer or is designed as an elastomer. The pump element is fixedly held in the holding ring, in particular in a force-fit or frictionally engaged manner. The geometry of the fastening elements, in particular their radial length, is selected in such a way that under no circumstances does the pump arrangement contact the pump housing. This advantageously ensures that vibrations of the pump arrangement are not transmitted to the pump housing and thus decoupled. The NVH (noise, vibration, harshness) behavior of the pump arrangement is thus advantageously optimized using only a single component, the suspension element. The suspension element, at least with regard to its outer contour, has an essentially rotationally symmetrical and/or mirror-symmetrical design with respect to its longitudinal center axis.

The fastening elements can each have a fastening section with a C-shaped cross section, and with their ends are each situated at the holding ring so that in each case a cavity is formed between the fastening element and the holding ring. This results in the advantage that movements of the pump element relative to the pump housing within the cavity, caused by deformation of the fastening section, for example due to vibrations during operation of the pump element, are possible without the pump element striking against the pump housing.

It is particularly preferably provided that a fastener for a housing opening in the pump housing is provided at a surface of the particular fastening section facing away from the holding ring. Such a fastener advantageously ensures that the suspension element together with the pump element is securely held at the pump housing.

It is also provided that axially following the holding ring, a mounting bracket can be provided, at which at least one axially protruding, further elastically deformable fastening element is provided, perpendicular to the fastening elements. Such a mounting bracket results in the advantage that the suspension element has additional support for the pump element in the axial direction.

It is particularly preferably provided that the further fastening element includes a further fastener for a further housing opening in the pump housing. Such a fastener advantageously ensures that the suspension element together with the pump element is securely held at the pump housing also in the axial direction.

At least one of the fasteners can have a rear engagement element. The rear engagement element results in the advantage that the suspension element together with the pump element is held at the pump housing in a form-fit manner.

The pump arrangement can include a pneumatic pump element and a pump housing, in particular of an adjustable lumbar support of a vehicle seat. The pump arrangement can be characterized in that the pump element can be supported in the pump housing by the suspension element according to the invention. This results in the advantages stated above.

It is particularly preferably provided that the pump housing can have at least two housing parts, and that at least one fastening element of the suspension element is partially supported in each case in a housing opening in each of the two housing parts. This ensures particularly advantageous simple installation of the suspension element before the two housing parts are joined together.

The vehicle seat for a motor vehicle having can be characterized in that the pump arrangement according to the invention is situated in or at in particular a seat frame of the vehicle seat, in particular of a backrest. This also results in the advantages stated above. The same advantages result when the vehicle seat is used in other forms of transportation, in particular aircraft, and also when the pump arrangement according to the invention is used in seats that are not installed in a transportation vehicle, for example arranged in seat massagers.

The motor vehicle can be characterized by at least one vehicle seat according to the invention, which also results in the advantages stated above. In particular, the motor vehicle has the vehicle seat as a driver's seat.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1A and 1B show advantageous suspension elements,

FIGS. 2A and 2B show the suspension elements mounted in a pump arrangement, and

FIG. 3 shows a sectional view of the pump arrangement.

### DETAILED DESCRIPTION

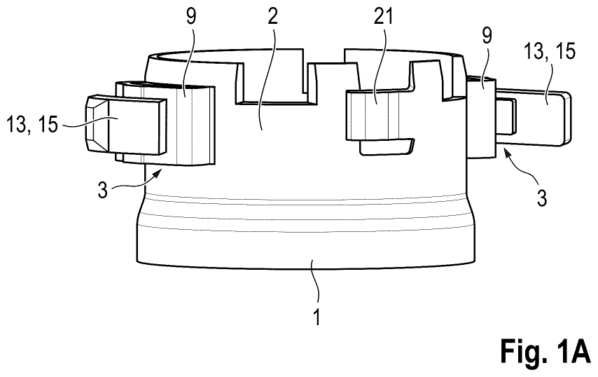

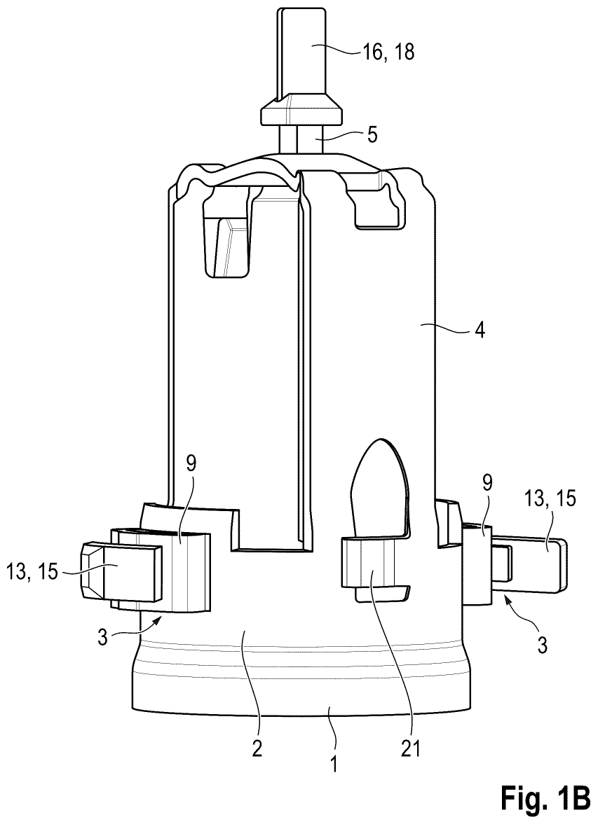

FIGS. 1A and 1B show a first and second exemplary embodiment of an advantageous suspension element 1 for an in particular pneumatic pump element in a pump housing. The suspension element 1 in each case has a holding ring 2 into which the pump element is insertable.

In addition, the suspension element 1 in each case has two fastening elements 3 which protrude radially from the holding ring 2, and which in the present case are uniformly distributed over the circumference of the holding ring 2. The fastening elements 3 are each designed in one piece with the holding ring 2 and are elastically deformable, at least in areas, in order to support the pump arrangement in the pump housing in a floating and vibration-damping manner.

In the second exemplary embodiment illustrated in FIG. 1B, axially following the holding ring 2, a mounting bracket 4 having a U-shaped cross section is provided, at which an axially protruding, further elastically deformable fastening element 5 is provided, perpendicular to the fastening elements 3. The mounting bracket 4 with its two ends is situated at the holding ring 2, and has a one-piece design with the holding ring 2.

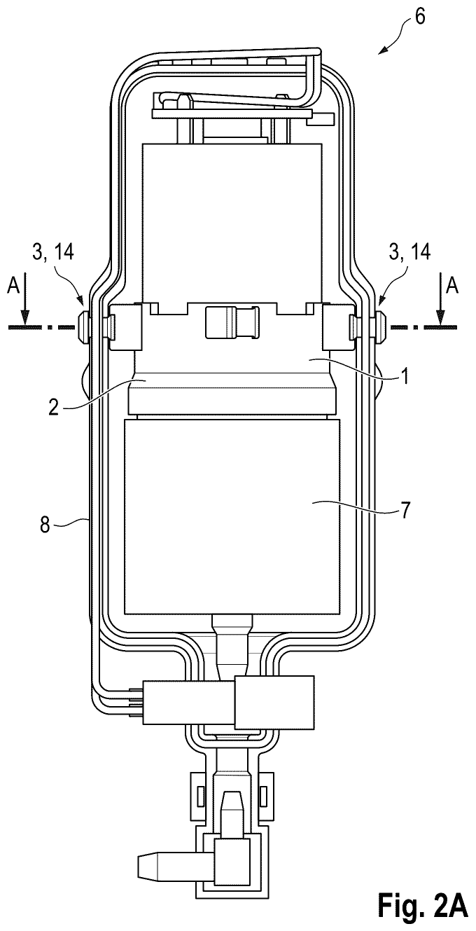

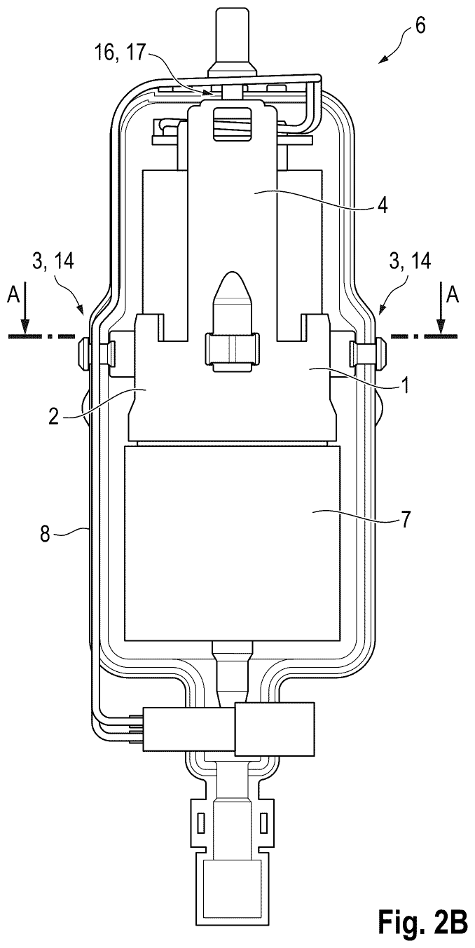

FIG. 2A illustrates the suspension element 1 from FIG. 1A, and Figure 2B illustrates the suspension element 1 from FIG. 1B, mounted in a pump arrangement 6. The pump arrangement 6 in each case has a pump element 7 and a pump housing 8. The pump element 7 is supported in the pump housing 8 by the respective suspension element 1.

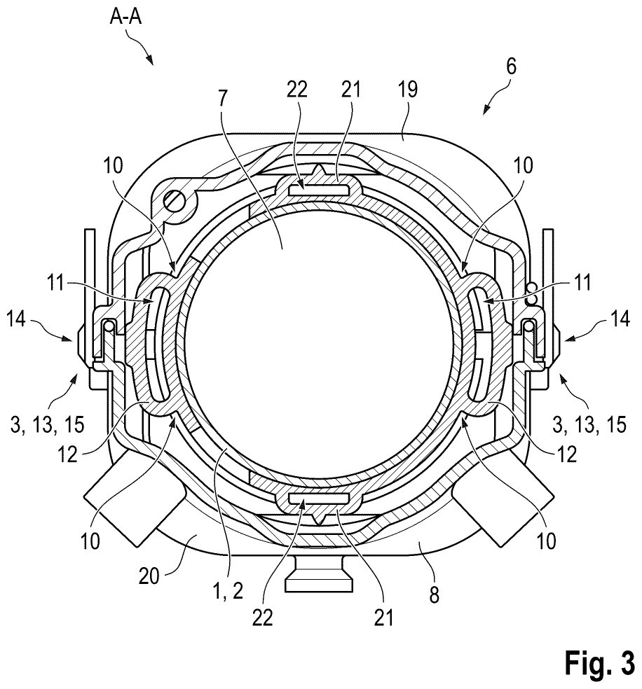

FIG. 3 shows a sectional illustration in a section plane A-A depicted in each case in FIGS. 2A and 2B. It is apparent that the fastening elements 3 each have a fastening section 9 with a C-shaped cross section, with their ends 10 each situated at the holding ring 2, so that in each case a cavity 11 is formed between the fastening element 3 and the holding ring 2.

The fastening elements 3 also have two damping elements 21 with a C-shaped cross section, each of which is situated at the circumference of the holding ring 2 and offset by 90°, i.e., at right angles, with respect to the fastening elements 3, so that the fastening elements 3 and the damping elements 21 together are uniformly distributed over the circumference of the holding ring 2.

The damping elements 21 are not connected to the pump housing 8; instead, the further cavity 22 formed in between ensures that for a corresponding movement of the pump element 7, only the damping elements 21 rest against the pump housing 8 and are elastically deformed, but the pump element 7 does not come into direct contact with the pump housing 8.

A fastener 13 for a housing opening 14 in the pump housing 8 is provided at a surface 12 of the particular fastening section 9 facing away from the holding ring 2. The fastener 13 in each case has a rear engagement element 15.

As is apparent in FIGS. 2A and 3A, the fastening element 5 analogously also has a further fastener 16 for a further housing opening 17 in the pump housing 8. The fastener 16 in each case has a further rear engagement element 18.

As is apparent in FIG. 3, in the present case the pump housing 8 has two interconnectable housing parts 19, 20, with at least the fastening elements 3 in each case being partially supported in each of the two housing parts 19, 20 to facilitate insertion of the fastener 13 into the pump housing 8.

The housing openings 14 are thus designed in each case as in particular semicircular depressions in each of the housing parts 19, 20, so that overall they result in particular in a circular through hole. The respective rear engagement element 14 is thus situated outside the pump housing 8.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A suspension element for a pneumatic pump element in a pump housing, in particular of an adjustable lumbar support of a vehicle seat, the suspension element comprising:
a holding ring into which the pump element is insertable; and
at least two fastening elements that protrude radially from the holding ring and that are uniformly distributed over a circumference of the holding ring, and that are designed in one piece with the holding ring and are elastically deformable, at least in areas, in order to support the pump element in the pump housing in a floating and vibration-damping manner.

2. The suspension element according to claim 1, wherein the fastening elements each have a fastening section with a C-shaped cross section, and with their ends are each situated at the holding ring so that a cavity is formed between the fastening element and the holding ring.

3. The suspension element according to claim 1, wherein a fastener for a housing opening in the pump housing is provided at a surface of the fastening section facing away from the holding ring.

4. The suspension element according to claim 1, wherein axially following the holding ring, a mounting bracket is provided, at which at least one axially protruding, further elastically deformable fastening element is provided, substantially perpendicular to the fastening elements.

5. The suspension element according to claim 4, wherein the further fastening element includes a further fastener for a further housing opening in the pump housing.

6. The suspension element according to claim 3, wherein at least one of the fastener has a rear engagement element.

7. A pump arrangement comprising:
a pump element; and
a pump housing for an adjustable lumbar support of a vehicle seat,
wherein the pump element is supported in the pump housing by the suspension element according to claim 1.

8. The pump arrangement according to claim 7, wherein the pump housing has at least two housing parts, and wherein at least one fastening element of the suspension element is partially supported in each case in a housing opening in each of the two housing parts.

9. A vehicle seat for a motor vehicle comprising the pump arrangement according to claim 7, the pump arrangement being situated in or at a seat frame of the vehicle seat or at a backrest.

10. A motor vehicle comprising at least one vehicle seat according to claim 9.
